(19) United States
(12) Patent Application Publication
(10) Pub. No.: US 2024/0279516 A1
(43) Pub. Date: Aug. 22, 2024

(54) HIGH TEMPERATURE RESISTANT ACRYLIC ADHESIVE

(71) Applicant: Illinois Tool Works Inc., Glenview, IL (US)

(72) Inventors: Jeffrey Gasa, Glenview, IL (US); Manoj Ajbani, Glenview, IL (US); Claudia Thibert, Glenview, IL (US); Katherine Scacchi, Glenview, IL (US); Steven Chao, Glenview, IL (US)

(73) Assignee: Illinois Tool Works Inc., Glenview, IL (US)

(21) Appl. No.: 18/441,283

(22) Filed: Feb. 14, 2024

Related U.S. Application Data
(60) Provisional application No. 63/446,861, filed on Feb. 19, 2023.

(51) Int. Cl. C09J 133/10; B32B 7/12; C09J 4/00; C09J 5/00; C09J 11/08; C09J 133/06

(52) U.S. Cl. CPC C09J 133/10; B32B 7/12; C09J 4/00; C09J 5/00; C09J 11/08; C09J 133/066; C09J 2423/04; C09J 2433/00

(57) ABSTRACT

A process of applying an adhesive to a substrate is provided that includes the mixing together of the components of a two-part formulation of a Part A and a Part B. The Part A includes a reactive methacrylate phosphate monomer or oligomer, a methacrylate monomer, a high flash point (meth)acrylate monomer, a free-radical polymerization inhibitor, an adhesion promoter, an impact modifier, a toughening agent, and a free-radical polymerization initiator. The Part B includes an impact modifier, a toughening agent, and a polymerization accelerator. The A and B Parts are combined together to form an adhesive mixture. The adhesive mixture is applied to the substrate. A formulation for the Part A and B is also provided. A bonded structure is provided in which the adhesive so created is intermediate between a first substrate and a second substrate.

### RELATED APPLICATIONS

This application is a non-provisional application that claims priority benefit of U.S. Provisional Application Ser. No. 63/446,861 filed Feb. 19, 2023; the contents of which are hereby incorporated by reference.

### FIELD OF THE INVENTION

The present invention in general relates to adhesives and in particular, to free-radical curing adhesives with strength maintenance after heating.

### BACKGROUND OF THE INVENTION

In many industries, manufacturers of mated components have changed to structural adhesives to replace conventional fastening techniques such as rivets, bolts, and welding. Adhesives in theory offer many attractive properties that include improved product performance, aesthetics, some reduced overall assembly time, and lower production costs. Additionally, adhesives preclude much of the stress point concentration, corrosion, and component damage often seen with rivets, bolts, welding, and other traditional fastening methods. Adhesives have made considerable progress in lowering assembly times versus some traditional mechanical fastening methods but depending on the application and assembly time can still suffer from detrimental effects due to work life of the adhesive. In many applications, if the assembly has not been completed before the material becomes a hard or gelled solid, the adhesive joint will not offer the strength needed to perform as designed. In many instances if this happens it can lead to expensive and time-consuming reworking costs. To mitigate these problems manufacturers can go to a material with longer work life. However, in proceeding this way the material will take a longer time to become of sufficient strength to move to the next step in an assembly which is known as “fixture time.” Typically, for adhesives, as the work life is increased the fixture time can increase dramatically.

A sufficient strength to move to the next step in the production process is known as the fixture time for an adhesive. The adhesive strength to move to another stage in a production process is problematic since it is very much dependent on the specifics of the production process and the product. Most often, bond strengths to a metal joint are used to define adhesive strength. American standard test method, ASTM D1002, “Standard Test Method for Apparent Shear Strength of Single-Lap-Joint Adhesively Bonded Metal Specimens by Tension Loading (Metal-to-Metal)” is a well-accepted standard for testing adhesive strength. Fixture time can be defined as the time of the adhesive to reach a defined adhesive strength.

Typically, acrylic adhesives are used in applications where fixture time or time until the part can be handled is critical in a production or repair. Fixture time can typically be improved by accelerating the adhesive with a catalyst, increasing curing agent, or reducing agent. However, in doing this, the work life, or time in which the material can be applied, is also reduced. If the work life is too short, the adhesive may be wasted, and the mating parts may not be properly adhered to each other. If the time to when the part can be handled, fixture time, is too long, repair or production time can be lost.

In the automotive industry, metal adhesive bonding generally includes steps such as a thorough cleaning of mating surfaces of the substrates, light sanding of the bonding surfaces, and use of an adhesion promoter and/or a primer. These steps are performed to make the surface of the substrates as receptive as possible to the adhesive. Contaminants left on the surface can reduce bond strength by interfering with the adhesive's ability to form a bond, producing a weaker chemical bond, or reduced bond area. Furthermore, the contaminant may provide a fracture initiation site when the bond is stressed, again reducing the load the joint can withstand. Therefore, the cleaning step to remove possible contaminants from a boding surface is generally required to ensure a good adhesive bond. Sanding surfaces removes gross surface imperfections, facilitating a bondline of consistent thickness and intimate contact between the adhesive and substrate. Priming can be an actual coating of another layer that provides a more consistent and bondable surface. An adhesion promoter can be used that “activates” the surface, providing chemical groups ready to latch onto the adhesive when applied. These preparations happen before paint is applied in an automotive factory, but not before applications such as hem flange bonding.

Hem flange bonding is performed before painting in a body shop of an assembly plant or at a metal fabrication plant and shipped to the assembly plant. The steel body panels, usually galvanized, are stamped and formed, processing which requires various lubricants to be applied, such as mill oils and drawing compounds, or pre-lubes. One or more of these lubricants may be present when the adhesive is applied, however no cleaning step to remove the lubricant occurs, partly because the lubricant also functions to prevent oxidation of the metal.

During hem flange bonding, after the adhesive is applied to an outer panel, an inner panel is positioned and the outer panel is bent or crimped around the inner panel, forming the hem flange. Bead size of the adhesive is carefully controlled to fill the bondline but to avoid squeeze out. Adhesives that escape the bondline may contaminate the equipment and cause cleanliness and maintenance issues in the manufacturing plant. A cure step may be introduced at this stage, such as induction curing. The cure step may be a full cure or just enough to prevent any movement of inner to outer panel during subsequent processing. The body closure panels are attached to the frame and sent to the paint shop where it is cleaned, primed, and painted. Cure of the adhesive is completed in the paint ovens.

One of the reasons for using an adhesive in the hem flange is to reduce or eliminate the use of spot welds to hold the inner and outer panels together. Spot welding is sometimes noticeable on the outer panel, necessitating a finishing or polishing step prior to painting to make the spot weld virtually invisible. The few remaining spot welds act as peel stoppers, reducing the susceptibility of the adhesive to any peel loads, and hold the panels together until the adhesive is cured. This processing step has brought new requirements to the adhesive related to weldability. First, the adhesive must not interfere with the integrity of the spot weld. Second, similar to the forming process, the adhesive must not escape the joint and get on the welding equipment.

With the further use of adhesives in manufacturing there is a demand for improved adhesive formulations that are suitable to bond metal substrates and be subjected to various finishing processes including painting, electric coating (E-Coat)/electrostatic painting, and powder coat post bake. There is a further concern with existing adhesives as to flammability that complicates industrial handling and usage thereof.

Electrostatic painting of various vehicle components presents an attractive and cost effective scheme as compared to usage of a conventional paint line. Electrostatic painting of vehicle parts, such as doors, hoods, quarter panels, and other vehicle skin parts can be routinely performed. Owing to the high visibility and environmental exposure encountered by such vehicle parts, a high quality paint finish surface is demanded with a high degree of reflectivity and a surface free of visual defects. Electrostatic painting requires the part to be electrically conductive and support an electrical potential on the part needed to attract oppositely charged paint aerosol droplets to the part. Therefore, bonding adhesives used to join parts that are subject to painting are generally required to be conductive to ensure that bonded pieces are charged at the same potential during a painting stage.

Thus, there exists a need for a structural adhesive formulation which can be used to increase work life while mitigating the extension of fixture time while being suitable for various finishing processes. There is a further need for structural adhesive formulations that are conductive so as to bond parts that provide surfaces that are amenable to receiving a highly uniform paint coating via electrostatic painting techniques.

### SUMMARY OF THE INVENTION

A process of applying an adhesive to a substrate is provided that includes the mixing together of the components of a two-part formulation of a part A and a part B. The Part A includes a reactive methacrylate phosphate monomer or oligomer, a part A methacrylate monomer, hydroxylated methacrylate monomer, a free-radical polymerization inhibitor, an adhesion promoter, a part A impact modifier, a part A toughening agent, and a free-radical polymerization initiator. The part B includes a Part B impact modifier, and a polymerization accelerator. The A and B parts are combined together to form an adhesive mixture. The adhesive mixture is applied to the substrate. The adhesive mixture is allowed to cure to form an adhesive sustaining bake temperatures of 205° C. for up to one hour without detrimental effects on adhesion to the substrate.

A formulation for the part A and B is also provided. A bonded structure is provided in which the adhesive so created is intermediate between a first substrate and a second substrate.

### DETAILED DESCRIPTION OF THE INVENTION

The present invention has utility as a curing adhesive particularly well suited for bonding structural substrates. Structural substrates operatively bonded by an inventive adhesive may include electrogalvanized steel, hot-dipped galvanized steel, cold-rolled steel, aluminum, aluminum alloys, polyacrylonitrilebutadiene—styrene (ABS), mild steel (MS), polyvinyl chloride (PVC), and fiberglass. An inventive adhesive formulation is appreciated to be operative to bond to like structural substrates, as well as to bond one such substrate to other substrates including other metals, other plastics, and to do so through a rapid handling strength during cure to facilitate handling and removal of fixturing devices in a manufacturing setting. In specific inventive embodiments conductive fillers are incorporated in the adhesive formulation to control electrical conductivity and/or thermal conductivity of the high temperature adhesive. The inclusion of conductive fillers in embodiments of the high temperature adhesive provides a conductive adhesive that forms an adhesive bond to electrically conduct a charge between bonded substrates that may then be electric coated (E-Coat)/electrostatic painted or powder coated. The conductive embodiments of the inventive high temperature adhesive may also be used to provide electromagnetic field (EMF) shielding by forming a Faraday cage with the bonded conductive surfaces. The conductive embodiments of the inventive adhesive may also provide improved thermal transfer between bonded materials that is advantageous for powder coating or heat dissipation.

Embodiments of the inventive adhesive formulation have a high level of product stability, a high flash point (non-flammable), high boiling point (low in volatile organic compounds (VOC) and low odor), and have a high heat resistance, while presenting a low health hazard with respect to adhesive substances such as tetrahydrofurfuryl methacrylate (THFMA). In some inventive embodiments, these results are achieved by replacing methyl methacrylate monomer in whole, or in part with a high flashpoint monomer. As a result, some inventive embodiments include no methyl methacrylate. Embodiments of the inventive adhesive formulation have a 1:1, 4:1, 10:1±0.10% mix ratio that are convenient for users and provides excellent adhesion to high contaminated metal surfaces with cutting and sampling oils, without using a primer. Embodiments of the inventive adhesive formulation can bond through a wider variety of stamping and cutting oils and are less brittle (higher elongation-at-break) than existing adhesive formulations. Embodiments of the inventive adhesive formulation are suitable to bond metal substrates and may be subjected to various processes including painting, electrodeposition coating (E-Coat), and powder coat post bake temperatures of 205° C. (400° F.) up to one hour without detrimental effects on adhesion or physical performance. Embodiment of the inventive adhesive formulation are well suited for bonding hem flange joints on metal components such as doors on various vehicles, and also provides the ability to be manipulated to afford various work times to accommodate other transportation and general industrial applications.

Embodiments of the inventive adhesive formulation allow for even distribution and flow of the adhesive while also providing longer working times than conventional compositions and with a rapid fixture subsequent to the working time that may be accelerated with a post heat cure. The high boiling point of the inventive adhesive formulation minimizes off gassing during the application process reducing odor and flammability and also imparts stability to temperatures of 205° C. (400° F.) up to one hour with maintenance of adhesion.

This present invention achieves the seemingly contradictory characteristics of increasing the work life while mitigating the extension of fixture time through resort to the use of a transfer agent, an induction delaying agent, or a combination thereof. The present invention does not contain chain transfer agents, but presumably it can be incorporated if one would like to further increase the worklife, but we have not done this experiment. The inventive formulation contains inhibitors, antioxidants, and stabilizers that help increase work life while mitigating the extension of fixture time. Without intending to be bound to a particular theory through agent selection the fixture time and work time properties are believed to be a result of a combination of thermodynamically and kinetically controlled processes.

It is to be understood that in instances where a range of values are provided that the range is intended to encompass not only the end point values of the range but also intermediate values of the range as explicitly being included within the range and varying by the last significant figure of the range. By way of example, a recited range of from 1 to 4 is intended to include 1-2, 1-3, 2-4, 3-4, and 1-4.

For the purpose of definition and defining a strength that is considered adequate for most production assemblies, fixture time as used herein is the time to reach the strength of 1 MPa as measured per ASTM D1002 with a half-inch overlap using a bond gap of 0.03 inches.

As used herein, (meth)acrylate refers to either a methacrylate or an acrylate.

As used herein, work life is defined as the time for the material to reach a state of gel as defined by a point in time after the material is first mixed when the storage modulus (G′) and the loss modulus (G″) are equal as defined by dispensing a bead of the material (˜20 grams) from a cartridge and through a tip mixer and then check manually with a tongue depressor the time it takes for the adhesive to start thickening.

As used herein, maintenance with respect to adhesive strength at elevated temperature is defined as the strength being within 10% of the room temperature strength measured immediately after cure.

Weight percentages as used herein, and unless noted to the contrary, refer to formulations exclusive of particulate fillers contained in a matrix of resin upon cure of the two part formulation. It is appreciated that particulate fillers can account for up to 90 total weight percent of a fully formulated formulation.

This invention uses an acrylic adhesive in a two-part adhesive formulation. It is provided as a binary system including an adhesive part A and an activator part B. The part A includes a methacrylate monomer, high flash point acrylate monomer; a free-radical polymerization inhibitor; and an adhesion promoter;. The part B includes a monomer reactant, a high flash point (meth)acrylate monomer, and a polymerization accelerator, with the proviso that an impact modifier and a free radical polymerization initiator are each present in a fully mixed curable formulation as separate parts or in at least one of part A or part B. Part A in some inventive embodiments includes reactive methacrylate phosphate monomer or oligomer, hydroxylated methacrylate monomer, or a combination thereof. Various additives are readily included to improve the handling properties of an inventive formulation. The amount of Part B varies in the weight ratio used relative to Part A. Each of the Part A and the Part B has separate storage stabilities of at least 180 days at 23° Celsius. While the present invention is detailed herein with respect to a 4:1 by weight ratio mixture of Part A:Part B, it is appreciated that other mix ratios are readily compounded ranging from 10-1:1 Part A:Part B without departing from the spirit of the present invention. Components common to both parts A and B, such as a monomer reactant, an impact modifier, and a toughening agent can be the same in both parts or different compounds present to impart the desired property to the resulting adhesive.

A process of applying an adhesive to a substrate is provided that includes combining together Parts A and B to form an adhesive mixture and applying the mixture to the substrate and allowing the applied mixture to cure.

Methacrylate phosphate monomer or oligomer, when present and operative herein illustratively include glycerol mono methacrylate phosphates; glycerol dimethacrylate phosphates; hydroxy(C₂₋₆ alkyl) methacrylate phosphates, such as hydroxylethylmethacrylate phosphates; bis-(methacryloxyethyl) phosphate; methacryloxypropyl phosphate; bis-(methacryloxypropyl) phosphate; bis-(meth acryloxy)propyloxyphosphate; methacryloxyhexylphosphate; bis-(methacryloxyhexyl) phosphate; methacryloxy octyl phosphate; bis-(methacryloxy octyl) phosphate; methacryloxy decyl phosphate; bis-(methacryloxydecyl) phosphate; caprolactone methacrylate phosphate; polymethacrylated polycarboxyl polyphosphonic acid; poly methacrylated polychlorophosphoric acid; and combinations thereof. Without intending to be bound to a particular theory, these methacrylate phosphate monomers and oligomers are believed to have chemical affinity for a variety of metal substrates and function as adhesion promoters that are amenable to free-radical cure. Typical loadings of methacrylate phosphate monomers or oligomers in a fully formulated inventive adhesive range from 0-5 total weight percent in a 4:1 by weight mixture of Part A to Part B.

The adhesive Part A includes, in some inventive embodiments, a methacrylate monomer reactive under cure conditions. The methacrylate monomer operative herein includes acrylate monomer, methacrylate monomer, acrylic acid monomer, methacrylic acid monomer, or a combination thereof. Specific Monomers operative in the present invention illustratively include methacrylic acid, C₁₋₁₆ amine acrylates, C₁₋₁₆ secondary amine acrylates, C₁₋₁₆ alkyl acrylic acids, epoxy C₁₋₁₆ acrylates, and combinations thereof. Specific monomers operative herein in addition to aforementioned methylmethacrylate include acrylate or methacrylate ester monomer is at least one of ethyl(meth)acrylate, isobornyl (meth)acrylate, butyl(meth)acrylate, octyl(meth)acrylate, ethyl hexyl (meth)acrylates, dodecyl (meth)acrylate, tetrahydrofurfuryl (meth)acrylate, stearyl (meth)acrylate, lauryl (meth)acrylate, 2-phenoxyethyl (meth)acrylate, methoxy polyethylene glycol mono (meth)acrylate, isodecyl (meth)acrylate, cyclic trimethylolpropane formal (meth)acrylate, trimethylcyclohexyl (meth)acrylate, caprolactone (meth)acrylate, tridecyl (meth)acrylate, cyclohexyl (meth)acrylate, 2-hydroxyl ethylacrylate, 2-hydroxyl (meth)acrylate, 3-hydroxyl propylacrylate, 1-hydroxyl-2 amino propylmethacrylate, 1-amino-2-hydroxyl propyl methacrylate, acrylamide, 1-amino-3-hydroxy propyl (meth)acrylate, 2-terbutyl amino ethyl (meth)acrylate, methacrylic acid, and glycidyl methacrylate or a combination thereof. It is appreciated that methyl methacrylate monomer is excluded in whole, or in part according to the present invention in favor of a high flashpoint monomer. Typical loadings of methacrylate monomers in a fully formulated inventive adhesive range from 5-40 total weight percent in a 4:1 by weight mixture of Part A to Part B.

The adhesive Part A in some inventive embodiments also includes a hydroxylated methacrylate monomer reactive under cure conditions. Hydroxylated methacrylate monomer reactants operative herein illustratively includes 2-hydroxypropyl methacrylate, 2-hydroxyethyl methacrylate, 2-hydroxy-1-methylethyl methacrylate, 2,3-dihydroxypropyl methacrylate, 4-hydroxybutyl methacrylate, glycerol 1,3-dimethacrylate, 2-(hydroxymethyl)acrylate bisphenol A ethoxylate dimethacrylate, or a combination thereof. It should be appreciated that hydroxylated methacrylate phosphates in the formulation are not counted also hydroxylated methacrylate monomer for the purposes of amounts. Typical loadings of hydroxylated methacrylate monomer, if present, in a fully formulated inventive adhesive range from 0-10 total weight percent in a 4:1 by weight mixture of Part A to Part B.

The adhesive Part A curable monomers collectively have a flash point of at least 90° C.

The adhesive Part A includes a high flash point (meth)acrylate monomer reactive under cure conditions. The high flash point (meth)acrylate monomer has a flash point of at least 90° C., and in some embodiments at least 94° C. High flash point (meth)acrylate monomers operative herein illustratively include benzyl methacrylate, benzyl 2-methylpent-2-enoate, benzyl €-2-methylhex-2-enoate, benzyl (2E)-2-ethenylpenta-2,4-dienoate, 5-O-benzyl 1-O-methyl (E)-pent-2-enedioate, benzyl (E)-2-methyl-4-prop-2-enoxybut-2-enoate, benzyl prop-2-enoate, methyl (E)-2-methylidene-9-phenylmethoxynon-3-enoate, benzyl (E)-3-methoxy-2-methylprop-2-enoate, ethyl 2-methyl-5-phenylmethoxypent-2-enoate, benzyl (2E)-2-methylhexa-2,5-dienoate, 4-phenylmethoxybutyl 2-methylprop-2-enoate, benzyl (2E,4E)-5-fluoro-2-methylhexa-2,4-dienoate, benzyl (2E)-2-ethenyl-3-methylpenta-2,4-dienoate, fluoro benzyl methacrylate, 2-(perfluorooctyl)ethyl acrylate, (perfluoroheptyl)methyl methacrylate, 2-(N-ethylperfluorooctasulfoamido)ethyl acrylate, 2-(perfluorohexyl)ethyl methacrylate, 2-(perfluoroisononyl)ethyl acrylate, isobornyl methacrylate, or a combination thereof. In some inventive embodiments, the high flash point acrylate monomer is present in both the Part A and Part B. Typical loadings of high flash point acrylate monomer in a fully formulated inventive adhesive range from 15-35 total weight percent in a 4:1 by weight mixture of Part A to Part B.

In some exemplary embodiments of the present invention, ultra-high molecular weight polyethylene (UHMW-PE) is present from 1-3 total weight percent upon mixing of Parts A and B, methacrylate is present up to 10 total weight percent, there is no curable monomer present with a flash point at standard temperature and pressure (STP) of less than 65° C. In still other inventive embodiments, a toughening agent is present in Part A, Part B, or in both Parts A and B.

In some inventive embodiments, a polymerization initiator is provided that is a sulfonyl chloride. Sulfonyl chlorides operative herein illustratively include chlorosulfonated polyethylene, tosyl chloride, methanesulfonyl chloride, benzenesulfonyl chloride, C₂-C₁₄ alkylsulfonyl chloride, and C₇-C₁₄ arylsulfonyl chloride, or a combination thereof, where an alkyl is intended to include linear, branched, cyclic, structures, as well as the aforementioned structures with pendant groups therefrom, while aryl groups include diaryls and monoaryls inclusive of pendant groups. A sulfonyl chloride is present in the present invention in Part A in either unprotected or encapsulated form, while a sulfonyl chloride is present in Part B only in encapsulated form. Typical loading of a sulfonyl chloride, if present, ranges from 0.0125-3.75 total weight percent of a combined Part A and Part B, not inclusive of any encapsulant or particulate fillers for 4:1 volume ratio Part A:Part B. It is appreciated that the sulfonyl chlorides can be used in combination with halogen chain transfer agents, and/or multifunctional chain transfer agents to adjust work time of the resulting formulation. It is appreciated that loadings can be higher if chloro-sulfonated polyethylene (CSPE) is used instead of tosyl chloride due to much higher MW per mole of sulfonyl chloride of CSPE) with CSPE amounts ranging from 0.1 to 8 total weight percent of a combined Part A and Part B, not inclusive of any encapsulant for 4:1 volume ratio Part A:Part B.

An encapsulant operative herein is detailed in U.S. Pat. No. 3,396,116, the details of which are hereby incorporated by reference.

In some inventive embodiments, a formulation is cured by polymerization initiator that is a chemical free-radical cure initiator. A chemical free-radical cure initiator operative herein includes organic peroxides, azo-type initiators, and combinations thereof. Peroxide initiators operative herein illustratively include diacylperoxides, hydroperoxides, ketone peroxides, peroxyesters, peroxyketals, dialkyl peroxides, alkyl peresters and percarbonates. Azo-type initiators operative herein illustratively include azobisisobutyronitrile (AIBN). Benzoyl peroxide (BPO) is a prototypical free-radical cure initiator. Chemical cure initiators are typically present from 0.0125-3.75 weight percent of a fully mixed formulation of parts A and B. An impact modifier operative herein illustratively includes methyl methacrylate-butadiene-styrene, nitrile rubber, a block copolymer of styrene or alpha methyl styrene and butadiene or hydrogenated butadiene, with high rubber graft having 50 percent rubber or more, ABS, natural rubber, or combinations thereof. It is further appreciated that methyl methacrylate terminated versions of any of the aforementioned are also operative herein as impact modifiers that cross link to the matrix formed by monomer/oligomer cure. The loading of an impact modifier depends on factors including weight ratio between adhesive Part and activator Part, impact modifier molecular weight, and impact modifier modulus. Typical impact modifier loadings range from 10 to 30 total weight percent for a 4:1 inventive formulation. In certain inventive embodiments, the impact modifier is present as a rubber component in combination with a toughening agent, for example, in the form of a core-shell rubber particle. In still other embodiments, the impact modifier is segregated into an activator, Part B of an inventive formulation, yet still serves to modify the failure mode of the cured adhesive. In some inventive embodiments, the impact modifier is present in both the Parts A and Part B.

An inventive formulation in some inventive embodiments also includes a toughening agent. A toughening agent is distinguished from impact modifier in the present invention in being resins that are either blended or dissolved and form a miscible blend/solution with the monomers and can significantly improve the performance of cured adhesives at low temperatures such as −40° F. (−40° C.) and at the same time does not cause a negative impact on the performance of cured adhesives at elevated temperatures such as 180° F. whereas core-shell structured impact modifiers that are rubber particle dispersions provide not only excellent impact strength but also non-sag, excellent thixotropic property and improved anti-sliding performance. Toughening agents operative herein illustratively can be chosen from a wide variety of elastomeric materials that form discrete particles or biphasic domains in a continuous resin matrix. For example, pre-reacted particles, butadiene-acrylonitrile copolymer, styrene/ethylene/styrene, alpha-methyl styrene/ethylene/alpha methyl styrene, alpha-methyl styrene/butadiene/alpha methyl styrene, styrene/butadiene/styrene (SBS) copolymers, styrene/isoprene/styrene (SIS) copolymers, styrene/ethylene/butadiene/styrene (SEBS) copolymers, styrene/butadiene (SBR) copolymers, styrene acrylonitrile (SAN), vinyl terminated butadiene co-acrylonitrile, glycidyl methacrylate functionalized butadiene co-acrylonitrile, hydroxy functionalized butadiene, isocyanate functionalized butadiene, amine terminated butadiene, epoxy terminated butadiene, maleinized poly-butadiene or -isoprene, or copolymers thereof. U.S. Pat. No. 6,660,805 includes examples of such malenized polymers and copolymers. as well as other pre-reacted materials may be added in particulate form to the resin composition.

A partial listing of useful pre-reacted elastomer rubbers operative as impact modifierse includes pre-reacted elastomer particles include acrylatebutadiene; butadiene; chloroprene; ethylene-propylene; ethylene-propylene-diene; isoprene; isobutylene; isobutylene isoprene (butyl rubber); styrene-butadiene; styrene-isoprene; acrylonitrile-butadiene; acrylonitrile-chloroprene; vinyl-terminated polybutadienes such as vinylpyridine-butadiene, vinylpyridine-styrene-butadiene; carboxylic-styrenebutadiene; chloro -isobutylene-isoprene (chlorobutyl rubber); bromo-isobutylene-isoprene (bromobutyl rubber); dialkysiloxane, polypropylene oxide); polyester urethanes; polyether urethanes; and mixtures thereof. Moreover, reactive liquid polymers (RLP's) also can be incorporated as the toughening component. RLP's contain functional groups, usually on their terminal ends but occasionally as pendant groups and react with the resin in situ to form elastomeric domains. Examples of RLP's include, without limitation, vinyl terminated butadiene acrylonitrile (VTBN), carboxyl terminated butadiene acrylonitrile (CTBN), amine-terminated butadiene acrylonitrile (ATBN), hydroxyl-terminated butadiene acrylonitrile (HTBN), epoxy-terminated butadiene acrylonitrile (ETBN), mercapto-terminated butadiene acrylonitrile (MTPN), vinyl-terminated butadiene (VTB), maleinized butadiene, phenoxy-terminated butadiene acrylonitrile (PTBN). In specific embodiments of the present invention, the toughening agent includes ultra-high molecular weight polyethylene (UHMW-PE), chloro-sulphonated polyethylene, neoprene, copolymers of ethylene acrylic elastomer, poly (methyl methacrylate)—grafted rubber, butadiene styrene acrylonitrile copolymer or combinations thereof. It is further appreciated that methyl methacrylate terminated versions of any of the aforementioned are also operative herein as toughening agents that cross link to the matrix formed by monomer/oligomer cure. It is appreciated that a toughening agent is present as a component of an adhesive Part, an activator Part, or both Parts of an inventive formulation. In specific embodiments of the present invention, a toughening agent is present only in an adhesive Part but it is appreciated that the amount of toughening agent present depends on characteristics of the toughening agent. Typical loadings of toughening agent in a fully formulated inventive adhesive range from 8 to 25 total weight percent in a 4:1 adhesive:activator formulation. In still other embodiments, ultra-high molecular weight polyethylene (UHMW-PE) is present.

In order to formulate an inventive adhesive formulation that achieves high strength without the need for a separate surface treatment prior to application of an inventive formulation, an adhesion promoter is provided within an inventive formulation. The adhesion promoter facilitates adhesion of a fully cured formulation of various substrates including galvanized substrates. An adhesion promoter is readily formulated into either an adhesive Part, an activator Part, or both Parts of an inventive formulation. In specific embodiments, the adhesion promoter is found only in the adhesive Part. Specific adhesion promoters operated in an inventive formulation illustratively a phosphate ester, a monofunctional phosphate, a difunctional phosphate, polymeric phosphate functionalized polymer, a (meth)acrylic acid, polymeric material with organic acid functionality, maleic acid, acid functionalized polymer such a maleic anhydride modified polybutadiene, citric di- or tri-methacrylates, polymethacrylated oligomaleic acid, poly methacrylated polymaleic acid, poly methacrylated poly methacrylic acid, a silane, or a combination thereof. Silane adhesion promoters operative herein illustratively include: 3-aminopropyltrimethoxysilane, 3-aminopropyltriethoxysilane, 3-glycidoxypropyltrimethoxysilane, 3-glycidoxypropyltriethoxysilane, (3-glycidoxypropyl) bis(trimethylsiloxy)methylsilane, (3-glycidoxypropyl)methyldiethoxysilane, (3-glycidoxypropyl) dimethylethoxysilane, (3-glycidoxypropyl)methyldimethoxysilane, methacryloxymethyltriethoxy silane, methacryloxymethyltrimethoxy silane, methacryloxypropyldimethylethoxysilane, methacryloxypropyldimethylmethoxysilane, methacryloxypropyltrimethoxysilane ethacryloxypropylmethyldimethoxysilane, methacryloxypropyltriethoxysilane, methoxymethyltrimethylsilane, 3-methoxypropyltrimethoxysilane, 3-methacryloxypropyldimethylchlorosilane, methacryloxypropylmethyldichlorosilane, methacryloxypropyltrichlorosilane, 3-isocyanatopropyldimethylchlorosilane, 3-isocyanatopropyltriethoxysilane, bis(3-triethoxysilylpropyl)tetrasulfide, and combinations thereof Typical loadings of adhesion promoter in an inventive formulation are from 0.5 to 10 total weight percent in a 4:1 adhesive:activator formulation.

An anti-oxidant is present in an adhesive and illustratively includes hydroquinone (HQ), butylated hydroxytoluene (BHT), 1,4-naphtoquinone, 2,6-Di-tert-butyl-4-(dimethylaminomethyl)phenol, (2,2,6,6-Tetramethylpiperidin-1-yl)oxyl or commonly known as TEMPO, 4-hydroxy-TEMPO or TEMPOL, butylated hydroxyanisole, 2,6-di-t-butyl cresol, 2,2′-methylene bis(6-t-butyl-4-methyl phenol), 2,2′-thio bis(6-t-butyl-4-methyl phenol), tert-butyl hydroquinone, di-tert-butyl hydroquinone, di-tert-amyl hydroquinone, methyl hydroquinone, p-methoxy phenol, tetrakis[methylene-3-(3′,5′-di-tert-butyl-4′-hydroxyphenyl)propionate]methane, N-(2-aminoethyl)-3-[3,5-bis(tert-butyl)-4-hydroxyphenyl]propanamide, 5,7-di-tert-butyl-3-(3,4,-dimethylphenyl)-3H-benzofuran-2-one, dilauryl thiodipropionate, dimyristyl thiodipropionate, tris(nonylphenyl) phosphite, and combinations thereof. Typical loadings of an anti-oxidant in an inventive formulation are from 0.05 to 6 total weight percent of in a 4:1 adhesive:activator formulation.

A polymerization accelerator present in an activator Part B is limited only by the desired kinetics of free radical polymerization desired and compatibility with other inventive composition components. Accelerators operative herein illustratively include dimethylamino pyridine; polyethyleneimine, N,N-dimethylaniline, modified dihydropyridines such as 3,5-diethyl-1,2-dihydro-1-phenyl-2-propylpyridine, 2-methylimidazole, 2-hydroxyethyl p-toluidine, ethanolamine, diethanolamine, diethylethanolamine, methyldiethanolamine, butyldiethanolamine, diethylamine, triethylamine, n-butylamine, 2,2-bipyridine, 1,10-phenanthroline, ammonia, alkylidene malonate, δ-iminomalonate, ethylazan, phenylamine, benzylamine, 1-benzofuran-2-amine, 4-quinolylamine, pentane-1,2,5-triamine, benzene-1,2,4,5-tetramine, bis(2-chloroethyl)amine, butyl(ethyl)methylamine, (2-chloroethyl)(propyl)amine, hexane-1-imine, isopropylidene amine, ethane-1,2-diimine, carbodiimide, o-acetylhydroxyamine, o-carboxyhydroxylamine, hydroxylamine-o-sulfonic acid, o-hydroxyaniline, phenylpropanolamine hydrochloride, catecholamine, indoleamine, or polyacrylamineand combinations thereof. Typical loading of an accelerator in an inventive formulation is from 0.3 to 3 total weight percent of in a 4:1 adhesive:activator formulation. Without intending to be bound to a particular theory, the accelerator is believed to react reacts to decompose the organic peroxide increase the cure rate of the adhesive.

An inventive formulation in certain embodiments also includes various additive such as chelating agents, corrosion inhibitors, thickeners, pigments, thixotropic agents, plasticizers, viscosity regulators, and combinations thereof. Such additives are limited only by the requirement of compatibility with the other components of an inventive formulation. Such additives are provided to balance or otherwise modify at least one property of an inventive formulation as to handling, storage, cure rate, or adhesive properties. Typical loading of each additive in an inventive formulation is independently from 0 to 5 total weight percent of in a 4:1 adhesive:activator formulation.

Particulate fillers operative in embodiments of the adhesive illustratively include wollastonite, hollow glass microspheroids, calcium carbonate, calcium silicate, alumina, alumina trihydrate (ATH), silica, talcs, dolomite, vermiculite, diatomaceous earth, kaolin clay, carbon black, graphene, ceramics, metals, and combinations thereof. Factors relevant in the choice of a particulate filler illustratively include filler cost, resultant viscosity of flow properties, resultant shrinkage, surface finish weight, fire retardancy, and chemical resistance of the thermoset formulation. Typical filler sizes are from 0.1 to 50 microns. Typical loading of particulate filler in an inventive formulation is from 0 to 10 total weight percent of in a 4:1 adhesive:activator formulation, but in other embodiments can be present up to 90 total weight percent. Such particulate fillers are not counted towards the weight percentage of cure components of an inventive formulation.

Typical component amounts for an inventive adhesive are provided in Tables 1A and 1B for Parts A and B, respectively.

Tables 1A and 1B. Typical component amounts for adhesive (Part A) and activator (Part B), where amounts are given in weight percentages unless otherwise noted:

TABLE 1A
ADHESIVE (Part-A)

| Component: | (4:1 Ratio) |
|---|---|
| Reactive methacrylate phosphate monomer or oligomer | 0-6.25 |
| Methacrylate monomer | 6.25-50 |
| Hydroxylated methacrylate monomer | 0-12.5 |
| High flash point (meth)acrylate monomer | 0-43.75* |
| Polymerization initiator | 0.0125-3.75* |
| Impact Modifier | 0-37.5* |
| Toughening agent | 0-31.25* |
| Adhesion promoter | 0-6.25* |
| Anti-oxidant | 0-7.5* |
| Optional additives each up to 5% | 0-remainder |

*present in at least one of Part A or Part B or added to mixture thereof

TABLE 1B
ACTIVATOR (Part B)

| Component: | (4:1 Ratio) |
|---|---|
| High flash point (meth)acrylate monomer | 0-60* |
| Impact Modifier | 0-50* |
| Toughening agent | 0-50* |
| Adhesion promoter | 0-25* |
| Anti-oxidant | 0-30* |
| Polymerization accelerator | 1.5-15 |
| Optional additives each up to 5% | 0-remainder |

*present in at least one of Part A or Part B or added to mixture thereof

An inventive formulation when fully formulated after combining Parts A and B in 4:1 ratio in total weight percentages are provided in Table 2.

TABLE 2
Fully formulated, yet absent particulate filler.

| Component: | (4:1 Ratio) |
|---|---|
| Reactive methacrylate phosphate monomer | 0-5 |
| or oligomer | |
| Methacrylate monomer | 5-40 |
| Hydroxylated methacrylate monomer | 0-10 |
| High flash point acrylate monomer | 15-35 |
| Polymerization initiator | 0.0125-3.75 |
| Impact Modifier | 10-30 |
| Toughening agent | 8-25 |
| Adhesion promoter | 0.5-10 |
| Anti-oxidant | 0.05-6 |
| Polymerization accelerator | 0.3-3 |
| Optional additives each up to 5% | 0-remainder |

A process is provided for producing an adhesive formulation produced by free radical polymerization that bonds well to the aforementioned substrates. An inventive formulation is a two-part formulation that is either premixed to initiate a time period pot life, or alternatively the two parts are co-applied to a substrate under conditions for polymerization to occur between the various monomers. In specific inventive embodiments, polymerization occurs at 24° C. in ambient atmosphere on other embodiments, polymerization is initiated by energy inputs such as heating, ultraviolet radiation exposure or other free radical formation mechanisms. In certain inventive embodiments in which the adhesive Part A, and activator Part B are present in a 4:1 volumetric ratio ±10%, storage stability of more than 180 days at 23° C. is obtained. Typical viscosities of Part A and B are each independently between 20,000 and 500,000 cPs. In some inventive embodiments the separate Part A and Part B viscosities are within ±50 percent of one another to facilitate mixing there between.

Regardless of the form of an inventive formulation, upon induction of pot life for the formulation, the formulation is present in simultaneous contact with two or more substrates with the substrates held in contact with the curing inventive formulation for an amount of time sufficient to achieve a bond between the substrates. An inventive formulation is well-suited for bonding galvanized substrates, cold rolled steel, aluminum, PVC, ABS, mild steel, vinyl polymers, wood, and fiberglass. Two such substrates can be brought together to form various adjoined structures such as a lap joint, butt joint, corner joint, edge joint, and T-joint. In still other embodiments, an inventive formulation is applied to a single substrate and allowed to cure to form a coating that offers substrate protection or is operative as a primer for subsequent material applications. As an inventive formulation cures through a free radical mechanism, an inventive formulation can be applied to a variety of thicknesses and still achieve polymerization throughout. Typical thicknesses of an inventive formulation between substrates range from 0.001-25 mm. The resulting adhesive is able to sustain a bake temperatures of 205° C. for up to one hour without detrimental effects on adhesion to the substrate.

An inventive adhesive in some embodiments rapidly builds strength to facilitate handling as measured by lap shear on mild steel at a thickness of 5 mm that reaches a strength of 0.34 MPa in between 30 and 35 minutes and 3 to 5 MPa by 50 minutes.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the described embodiments in any way. Rather, the foregoing detailed description will provide those skilled in the art with a convenient roadmap for implementing the exemplary embodiment or exemplary embodiments. It should be understood that various changes may be made in the function and arrangement of elements without departing from the scope as set forth in the appended claims and the legal equivalents thereof.

1. A process of applying an adhesive to a substrate comprising:
mixing together the components of a two-part formulation of a Part A and a Part B, said Part A comprising: a Part A methacrylate monomer, a high flash point (meth)acrylate monomer, a free-radical polymerization inhibitor, a Part A impact modifier, and said Part B comprising: a Part B impact modifier and a polymerization accelerator;
combining together said two parts to form an adhesive mixture a free radical polymerization initiator, polymerization accelerator and toughening agent present in the mixture of said Part A and said Part B or added thereto as additional components;
applying said adhesive mixture to the substrate; and
allowing said adhesive mixture to cure an adhesive, the adhesive sustaining a bake temperatures of 205° C. to one hour without detrimental effects on adhesion to the substrate.

2. The process of claim 1 wherein the volume ratio of adhesive Part A to activator Part B is 10-1:1±0.10% or 4:1±0.10%.

3. The process of claim 1 further comprising contacting a second substrate with said mixture during cure to create a bond between the substrate and the second substrate.

4. The process of claim 1 further comprising fixturing in a fixture the substrate and said second substrate in a joint position and in simultaneous contact with said mixture for a period of time between 5 and 180 minutes during the free-radical cure and then releasing the substrate and the second substrate from the fixture.

5. A two-part adhesive formulation comprising:
an adhesive Part A comprising: a Part A methacrylate monomer, a high flash point (meth)acrylate monomer, a Part A impact modifier, a Part A toughening agent; and
an activator Part B comprising: a Part B impact modifier, a Part B toughening agent, a Part B monomer, a free-radical polymerization initiator, and a polymerization accelerator.

6. The formulation of claim 5 wherein further comprising a methacrylate phosphate monomer or oligomer.

7. The formulation of claim 6 wherein said methacrylate phosphate monomer or oligomer is at least one of a glycerol mono methacrylate phosphate, a glycerol dimethacrylate phosphate, a hydroxyethyl methacrylate phosphates, a bis-(methacryloxyethyl) phosphate, methacryloxypropyl phosphate, bis-(methacryloxypropyl) phosphate, bis-(meth acryloxy)propyloxyphosphate, methacryloxyhexylphosphate, bis-(methacryloxyhexyl) phosphate, methacryloxy octyl phosphate, bis-(methacryloxy octyl) phosphate, methacryloxy decyl phosphate, bis-(methacryloxydecyl) phosphate, caprolactone methacrylate phosphate, polymethacrylated polycarboxyl polyphosphonic acid, poly methacrylated polychlorophosphoric acid, or combinations thereof.

8. The formulation of claim 6 wherein said methacrylate phosphate monomer or oligomer is present from 0.3 to 5 weight percent upon mixture of said Part A with said Part B.

9. The formulation of claim 6 wherein said Part A monomer or said Part B monomer is each independently at least one of (meth)acrylate monomer, acrylic acid monomer, methacrylic acid monomer, acrylate or methacrylate ester monomer C₁₋₁₆ amine acrylates, C₁₋₁₆ secondary amine acrylates, C₁₋₁₆ alkyl acrylic acids, epoxy C₁₋₁₆ acrylates, and combinations thereof.

10. The formulation of claim 6 wherein said Part A monomer reactant is the same as said Part B monomer reactant.

11. The formulation of claim 6 wherein the formulation is exclusive of methyl methacrylate monomer.

12. The formulation of claim 6 wherein said high flash point (meth)acrylate monomer has a flash point of at least 90° C.

13. The formulation of claim 6 further comprising a high flash point (meth)acrylate monomer in said Part B.

14. The formulation of claim 6 wherein said high flash point (meth)acrylate monomer is present is present from 15 to 35 weight percent upon mixture of said Part A with said Part B.

15. The formulation of claim 6 wherein said impact modifier is present from 10 to 30 weight percent upon mixture of said Part A with said Part B.

16. The formulation of claim 6 wherein said toughening agent is present from 8 to 25 weight percent in a fully formulated adhesive upon mixture of said Part A with said Part B.

17. The formulation of claim 6 further comprising a hydroxylated methacrylate monomer in said Part A.

18. The formulation of claim 6 wherein said adhesion promoter is present from 0.5 to 5 weight percent in a fully formulated adhesive upon mixture of said Part A with said Part B.

19. The formulation of claim 6 wherein said toughening agent is ultra-high molecular weight polyethylene (UHMW-PE),

20. A bonded structure comprising:
a first substrate;
a second substrate; and
an adhesive created by the cure of the formulation of claim 6 intermediate between said first substrate and said second substrate.
